(19) United States
(12) Patent Application Publication
(10) Pub. No.: US 2008/0126418 A1
(43) Pub. Date: May 29, 2008

(54) Method and Apparatus to Store Content and a Query on a Device

(75) Inventors: Fabio Vignoli, Veldhoven (NL); Steffen Clarence Pauws, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/815,374

(22) PCT Filed: Feb. 9, 2006
(86) PCT No.: PCT/IB06/50437

§ 371 Date: Aug. 2, 2007

Related U.S. Application Data
(60) Provisional application No. 60/652,081, filed on Feb. 11, 2005.

(51) Int. Cl. G06F 17/00

(52) U.S. Cl. 707/104.1

(57) ABSTRACT

When playing back content identified on the playlist, it is determined if each of the content items is available. For a given content item that is not available, an additional content item (relevant content item) that is available and that corresponds to selection criteria is determined. The relevant content item and/or a new playlist is presented to a user for approval. The selection criteria is expanded to include a content item not previously identified if an additional content item is not available or is not approved.

This specification relates to a system and method for storing content and a query on a device. The content and query may also be transferred to a second device.

In the present day, the user of content typically has a huge amount of content that is available that provides the user with a tremendous range of content choices. For example, a user of an audio player typically is provided with a tremendous selection of audio content that may be stored locally in a local content storage device, for example, such as a local solid-state memory, a local optical memory (e.g., a CD-ROM drive), and/or a local hard drive device. In addition, the user may be provided with other content storage devices that are remote such as are available over the Internet and/or a network connected content storage device. To facilitate the playback of subsets of a content collection, the user typically is enabled to define lists of content having unique identifiers that may be stored together with the content or at some remote site. In this way whenever the user desires the playback of a particular subset of the content collection, the user may simply select the unique identifier associated with that particular subset.

For example, with regard to a collection of audio music content, a user may manually select a group of songs that are all written by a particular artist and then associate these songs with a playlist identifier that corresponds to the artist's name. In this way, any time the user wishes to listen to the songs of this artist, the user may simply select the playlist identifier that corresponds to the artist name and the device typically will play the corresponding group of songs. This group of songs together with the corresponding playlist may also be transferred to another device to simplify playing the group of songs in the same way (as a group) on the other device.

In another known system, only the playlist is transferred to expedite and simplify playing of the playlist on another device. Such a system is described in U.S. Patent Publication No. US 2004/0057348 A1, filed on Sep. 5, 2002, hereinafter referred to as the '348 patent Publication, which is commonly assigned and incorporated by reference as if set out in entirety herein. The '348 patent Publication describes a system where an original playlist is created in a first location having a first storage location for storing music and the playlist. When the playlist is transferred to a second location having access to a second storage location, the second storage location is searched for the songs contained in the playlist. In the event that a song from the playlist is not found, the playlist is updated to reflect a “not found” indication so that the rest of the playlist may still be played. In a case where none of the content from the transferred playlist is available, selection of the playlist will result in no content being played.

In yet another known system, a query containing content related search criteria (e.g., songs by the Beatles™ having a tempo of less then 100 beats per minute (bpm)) is stored in place of a playlist containing unique content identifiers. The query is provided with a unique identifier to facilitate repetitive playing of the content. Such a system is described in US Patent Publication No. US 2003/0065639 A1, filed on Sep. 28, 2001, hereinafter referred to as the '639 patent Publication, which is incorporated by reference as if set out in entirety. However, in this system each time the unique identifier associated with the query is selected, the query is executed and any content corresponding to the query is selected. This system may result in additional and/or completely different content being selected from the same content identifier when additional content is available. The user however may simply want a previous selection of content to be once again selected and therefore may not desire this result.

Accordingly, it is an object of the present invention to overcome these disadvantages and/or others of the prior art.

The present system includes devices, methods, etc., for playing electronic content items including audio content, video content, and/or data content that is identified on a playlist. In accordance with an embodiment, when trying to play back content identified on the playlist, the system determines whether each of the content items is available. The system then identifies for a given content item that is not available, an additional content item (relevant content item) that is available and that corresponds to selection criteria. The system may present the relevant content item and/or may present a new playlist to a user for approval. The system may expand the selection criteria to include a content item not previously identified if an additional content item is not available or is not approved.

The following are descriptions of illustrative embodiments that when taken in conjunction with the following drawings will demonstrate the above noted features and advantages, as well as further ones. In the following description, for purposes of explanation rather than limitation, specific details are set forth such as the particular architecture, interfaces, techniques, etc., for illustration. However, it will be apparent to those skilled in the art that other embodiments that depart from these specific details would still be understood to be within the scope of the appended claims. Moreover, for the purpose of clarity, detailed descriptions of well-known devices, circuits, and methods are omitted so as not to obscure the description of the present invention.

It should be expressly understood that the drawings are included for illustrative purposes and do not represent the scope of the present invention. In the figures, like parts of the system are denoted with like numbers.

The invention is best understood in conjunction with the accompanying drawings in which:

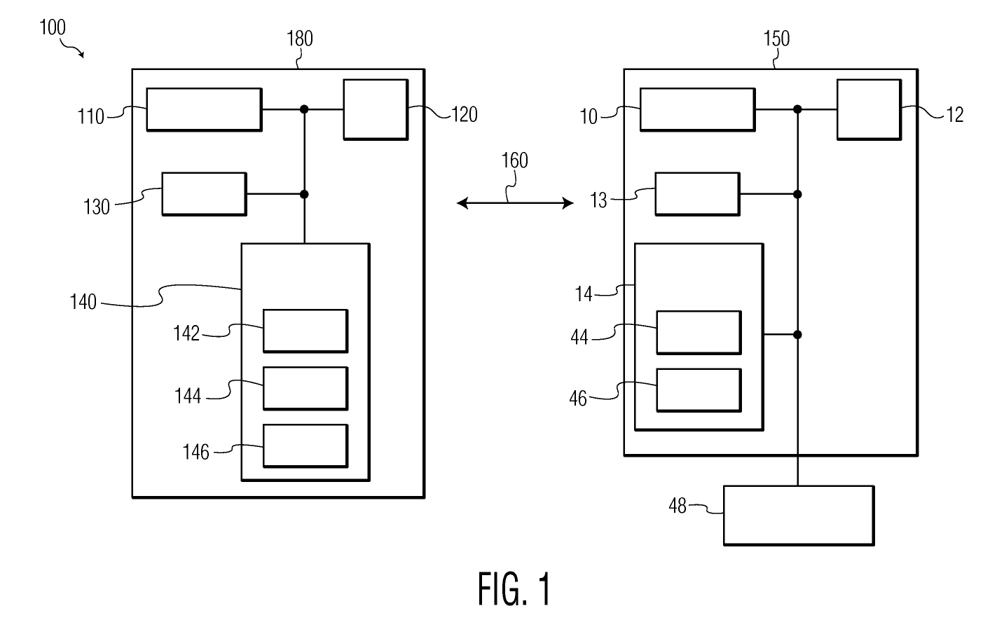

FIG. 1 shows an illustrative system in accordance with an embodiment;

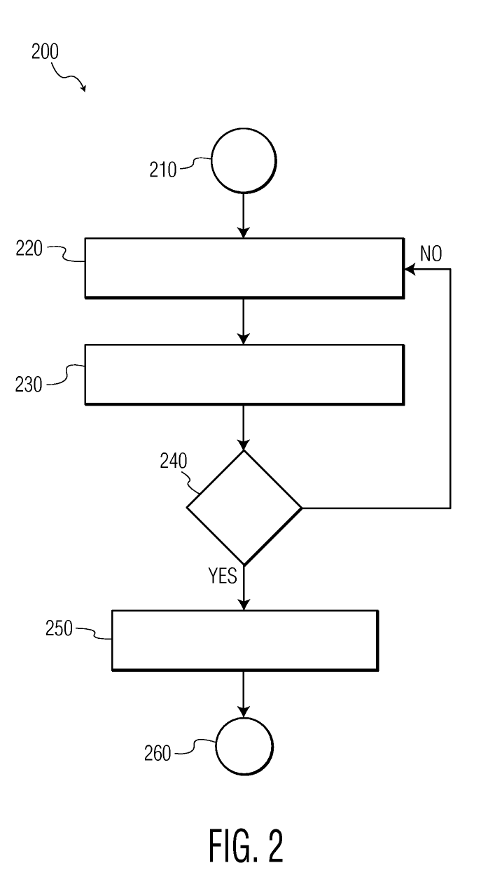

FIG. 2 shows a flow diagram illustrating operation of creating a playlist in accordance with an embodiment; and

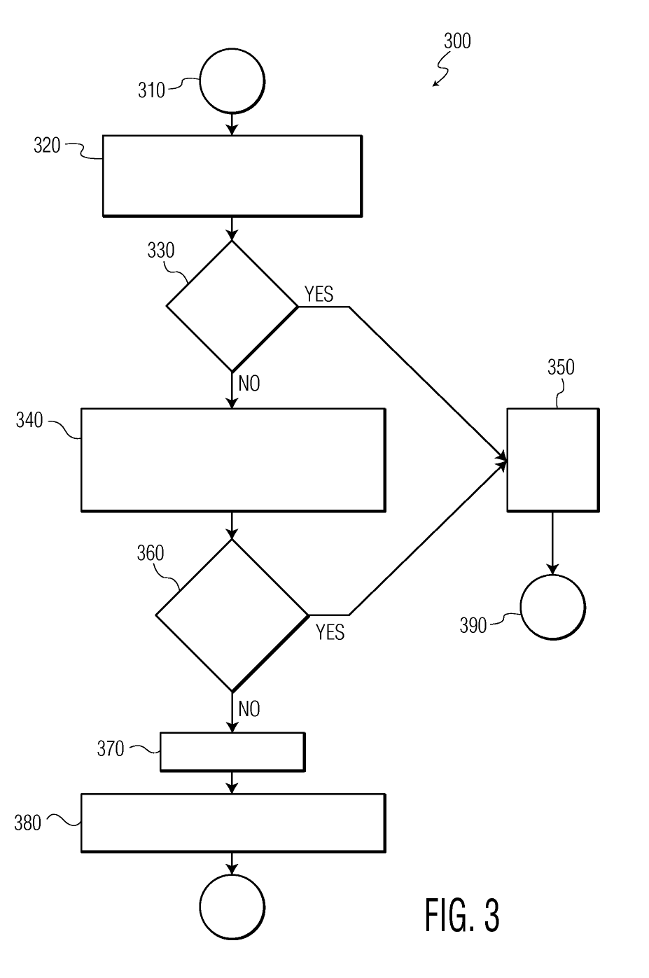

FIG. 3 shows a flow diagram illustrating operation of using a playlist in accordance with an embodiment.

The present system and method will be described below with reference to an illustrative system. The present system is applicable to other content including, without limitation, audio content, video content, and/or data content. For illustrative purposes and to simplify the following discussion, the present system will be described below with regard to an audio player and audio content. In addition, each type of content has ways in which a user observes it. For example, music and audio/visual content may be provided to the user in the form of an audible and/or visual signal. Data content may be provided as a visual signal. A user observes different types of content in different ways. For the sake of brevity, the term content consumption is intended to encompass ways in which content is suitably viewed, listened to, etc. by the user. The present system is applicable to numerous alternate embodiments that would readily occur to a person of ordinary skill in the art. The alternate systems are encompassed by the appended claims.

FIG. 1 shows a system 100 in accordance with an embodiment including an audio player 180 and an audio player 150. Each of audio player 180 and audio player 150 are shown similar in construction to simplify the discussion. The audio player 180 has a controller shown as processor 110, a user input 120, a display 130, and a storage device 140, shown operably coupled together. The storage device 140 is illustratively shown containing a content portion 142 for storing content such as songs, a playlist storage portion 144, and a query storage portion 146, for storing the query criteria.

The audio player 150 has a processor 10, a user input 12, a display 13, a storage device 14, and a distributed storage device 48, shown operably coupled together. The storage device 14 is illustratively shown containing a playlist storage portion 44 and a query storage portion 46. Each of audio devices 180, 150 is provided with a system for providing the content to the user for consumption, although this may not be shown (e.g., a speaker for audio content).

The storage devices may be any type of storage devices or combinations thereof including discrete circuitry (e.g., random access memory (RAM), read only memory (ROM), etc.), solid-state circuitry, optical storage (e.g., CD-ROM), magnetic storage (e.g., hard drive, tape, etc.) and/or any other memory or combinations of known memory/storage devices. In addition, the storage device 140 is shown contained within the audio player 180 while the audio player 150 is shown having access to a storage device 14 and a distributed storage device 48. Each of these configurations is merely for illustration. In fact, numerous other configurations may be suitably utilized. For example, all or portions of storage device 140 and/or storage device 14 may be contained on removable media. In this way, data (e.g., songs, playlist, query data, or any portions thereof) may be freely moved from one device to another device. In addition, the data may be available via a delivery means, including satellite, cable, wire, television broadcast, and/or an Internet connection. It should be noted that the present system is also capable of being connected to distributed networks, such as a direct private network, a wireless network, and/or any other operable link wherein the content, playlist, etc. may be available to the audio player(s). Any of the above, or other known systems may be suitably utilized in accordance with the present invention.

Further operation will be illustrated with reference to FIGS. 2, 3, and previously discussed FIG. 1. FIG. 2 shows a flow diagram 200 illustrating operation of creating a playlist in accordance with an embodiment. This operation will illustratively be discussed with regard to the audio player 180. Specifically, the process is started during act 210 when a user decides to generate query criteria to create a playlist. In operation, the user may use the user input 120 to indicate to the processor 110 that generation of the criteria is desired. The audio player 180 (and the audio player 150 for that matter) may contain a suitable user interface (UI) including program portions that may be stored in the storage device 140 for enabling the user to operate the audio player 180 conventionally, as is known in the art, and for operation in accordance with the present system. The audio player 180 may use the display 130 as a portion of this UI.

During act 220, the user via the UI specifies query criteria for the generation of a playlist. Many types of criteria are known including genre criteria (e.g., for music content, rock, pop, etc.), a year or period of preference, performer/artist, tempo (e.g., beats per minute, and/or more generally, slow medium, fast, etc.).

In addition or in place of the above criteria, the query may include a degree of preference or disfavor for given criteria. For example, a user may specify through use of the UI that they like popular music (pop), by for example, giving pop a criteria rating of 2 stars. In addition, the user may want to indicate a stronger preference for another criteria, such as rock and roll music and/or a disfavor for other criteria. In this case, the user may assign rock and roll a rating of 3 stars and assign an artist, such as Janet Jackson, a negative indication.

The criteria indication may even include an indication that the user prefers songs like another given song or group of songs. Alternatively, the songs identified for a playlist may be utilized to determine corresponding criteria. In this embodiment, characteristics of the songs in the playlist may be analyzed by the processor 110 to determine criteria that corresponds to the playlist. Other criteria may designate that the user desires a playlist of a given number of songs. These and other criteria are encompassed herein.

After the user has finalized the query including the criteria, during act 230 the audio player 180 via the processor 110 generates a playlist that corresponds to the query and the songs available for selection, for example, songs stored in the song portion 142 of the storage device 140. This playlist may be presented to the user for the user to determine whether the user is happy with the song selection during act 240. In the event that the user is not happy with the song selection, then the user may be directed back to act 220 to adjust the criteria selection.

When the user is satisfied with the selected criteria (e.g., as determined by the generated playlist), then during act 250, the processor 110 may cause the storage device 140 to store the playlist and the associated query utilized to generate the playlist. In an embodiment wherein the user simply specifies a playlist, acts 230 and 240 may be skipped and during act 250, the processor 110 may cause the storage device 140 to store simply the playlist.

The playlist may be provided with a unique identifier to enable the user to recall the playlist. Naturally, the playlist may be utilized by the audio player to play the given song selection for consumption by the user as would be readily appreciated.

FIG. 3 shows a flow diagram 300 illustrating operation of utilizing a previously created playlist in accordance with an embodiment. This operation will illustratively be discussed with regard to the audio player 150 and a playlist that was previously created on another audio player, such as the audio player 180. In accordance with an embodiment, the playlist and associated query that was created on the audio player 180 is transferred to the audio player 150 over a transfer medium 160. The transfer medium may be any medium that may suitably transfer the playlist and query. For example, in another embodiment the playlist and query may be stored on a removable medium at the audio player 180. Sometime thereafter, the removable medium with the playlist and query may be moved to the audio player 150. All or a portion of the songs may also be optionally transferred or be available on the audio device 150.

In any event, the process is started at act 310. During act 320, the user directs the audio player 150, for example using a UI available on the audio player 150, to load a previously created playlist. In accordance with an embodiment, the playlist and the associated query previously created are both available. During act 320, the user instructs the audio player 150 to load the playlist. During act 330, the audio player 150 utilizes the processor 10 to search available storage devices (e.g., any storage devices available to the audio player 150, such as storage device 14 and distributed storage device 48) for the songs that are identified in the playlist. If the processor 10 finds all the songs on the playlist, then during act 350, the audio player 150 will begin to play the songs and thereafter, end during act 390.

If the processor 10 does not find some portion of the songs from the playlist (e.g., does not find one or more songs), then during act 340, the processor utilizes the stored query that was originally utilized to create the playlist (see, act 220 discussed herein above), to identify relevant songs that are currently available to replace the songs that are not available. In terms of this system, a relevant song is a song that meets the criteria from the original query, and in one embodiment, is the song or songs (when more than one song must be replaced), that best meet the criteria, that are not already on the playlist, and that are available to the processor 10. In this way, a new playlist is created from the original playlist, with the songs that are not available from the original playlist, replaced with relevant songs. This ensures that the original playlist will be substantially similar to the new playlist. In this way, the audio player will not provide a substantially different grouping of songs as long as some of the original songs are available.

The new playlist may subsequently be presented to the user for review and approval. The new playlist may contain an indication of songs that where replaced from the original playlist to facilitate review. If the user approves of the new playlist during act 360, then during act 350, the audio player 150 will begin to play the songs as before. If the user does not approve of one or more of the newly selected songs or relevant songs are not identified utilizing the original criteria, then the processor 10 during act 370 may selectively relax the original criteria to identify other relevant songs that substantially meets the original criteria. This relaxing act may include selecting the song that next best meets the query criteria.

Another example of a relaxing act of the original selection criteria, when the query consists of a conjunction of criteria, may include removing a portion of the criteria. For example, a criteria or portions thereof may be removed by starting with the criteria that has minimal coverage in the collection. This act may be repeated until relevant songs are identified. Removing criteria that has minimal coverage provides a means to find relevant songs that maximally respect the original query. For example, if the original query consists of “jazz AND piano AND ‘Keith Jarrett’”, it may be better to remove the criteria ‘Keith Jarrett’ first than either of the other two criteria (depending perhaps on personal preference) if desired. In this example, it is likely that ‘Keith Jarrett’ will have a smaller coverage/impact than the other two criteria.

In the event that a query contains a cardinality constraint, that cardinality may be gradually relaxed until relevant songs are found. For example, if the playlist contains 40% jazz music, that percentage can be lowered. When the query contains a threshold or range function, the threshold/range may be gradually loosened until relevant songs are found. For instance, if items in the playlist are similar to each other with respect to a threshold, lowering this threshold results in a relaxation of this constraint. The range may be extended for a query that contains a range constraint over a time period (e.g., music from the seventies).

An implicit act may include installing cost functions for one or more criteria in the original query. A cost function may be expressed as a piecewise linear penalty function that controls the extent to which a criteria may be violated in a proportional manner. For example, one exemplary penalty function for a cardinality (e.g., percentage) constraint for a playlist that a user desires to contain N songs may be expressed as:

|0,a<=x<=bf(x,a,b,N)={(a−x)/max{a,N−b},x<a|(x−b)/max{a,N−b},x>b

where “x” is the current number (or percentage) of songs in the playlist that meet a particular description (e.g., x songs of ‘Jazz music’); where “a” is the minimum cardinality that should meet a particular description (e.g., “a” % of ‘Jazz music’ is at a minimum required); and where “b” is the maximum cardinality that should meet a particular description (e.g., “b” % of ‘Jazz music’ is at most required). A combination of all cost functions involved results in an overall penalty function that may be minimized when relevant songs are not available in the collection of songs. A standard optimization technique, such as local search and simulated annealing may be utilized to solve such minimization problems.

In any event, after a suitable relaxed criteria is utilized, the processor 10 then may generate a new playlist during act 380 again replacing unavailable songs with relevant songs that meet or best meet the relaxed criteria. This new playlist is then presented to the user for approval. This new playlist may again be approved or disapproved by the user. When the new playlist is approved, the audio player may then play the new playlist. When the new playlist is disapproved, step 370 may be performed iteratively until an acceptable playlist is created and approved. In another embodiment, songs that are replacing unavailable songs may be individually presented to the user for approval in place of or in addition to the new playlist.

In an embodiment wherein no query is available to the processor 10, then during act 340 the processor 10 may first analyze the original playlist to determine corresponding criteria. For example, if the original playlist contains rock music from the 1970s, then the processor 10 may search the available music to find other rock music from the 1970s that are available and are not on the original playlist. In another embodiment, the processor 10 may individually analyze the unavailable song from the original playlist to determine criteria that corresponds to the unavailable song. In this way, the processor 10 may find relevant songs that correspond to the unavailable song (as far as selection criteria) from the original playlist. In these or similar embodiments, the processor 10 may determine the selection criteria locally (e.g., at the audio player 150) or may utilize information available from a distributed storage device, such as distributed storage device 48. For example, in one embodiment the audio player 150 may access the distributed storage device 48 which may simply contain a lookup table of songs with corresponding criteria.

The embodiments of the invention described above are intended for purposes of illustration only, and should not be construed as limiting the appended claims to any particular embodiment or group of embodiments. Numerous alternative embodiments may be devised by those having ordinary skill in the art without departing from the spirit and scope of the following claims. For example, while the above is described with regard to creating a playlist on one device and playing back content from the playlist on another device, the previously created playlist may be played back on the same device that was utilized to create the playlist. New or different songs may become available to a given device based on removable or distributed memory that is available at one given time (e.g., such as when the playlist is first created), but is then unavailable or replaced with other memory at another time (e.g., when the playlist is subsequently selected for play). In another embodiment, the playlist may be created separate from the query and corresponding criteria. In this embodiment, a playlist may be created through any known means. A query is separately created and used in accordance with this embodiment, to identify relevant songs when a given song listed in the playlist is unavailable. This way, the system operates similar as described above except that the query is not utilized to generate the original playlist.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated

The claimed invention is:

1. A method for playing content items on an electronic media player, the content items being identified on a playlist, the method comprising the acts of:
identifying each of the content items contained in the playlist;
determining whether each of the content items is available; and
identifying for a given content item that is not available, an additional content item that is available that corresponds to selection criteria.

2. The method of claim 1, comprising the act of presenting the additional content item to a user for approval to be added to the playlist.

3. The method of claim 2, comprising the act of presenting a further additional content item to a user if the additional content item is not approved.

4. The method of claim 2, comprising the act of expanding the selection criteria to include a content item not previously identified if an additional content item is not available that is approved.

5. The method of claim 1, wherein the playlist is a first playlist, the method comprising the act of creating a second playlist containing identifiers for available content items and identified additional content items.

6. The method of claim 5, comprising the act of presenting the second playlist to a user.

7. The method of claim 1, comprising the act of expanding the selection criteria to include a content item not previously identified if an additional content item is not available that corresponds to the selection criteria.

8. The method of claim 7, wherein the playlist is a first playlist, the method comprising the acts of:
creating a second playlist containing identifiers for available content items and identified additional content items;
presenting the second playlist to a user for approval; and
repeating the expanding of the selection criteria to include a content item not previously identified if an additional content item is not available that corresponds to the expanded selection criteria.

9. A playback device, comprising:
a memory (14) configured to store a list of content items and a list of selection criteria; and
a processor (10) operationally coupled to the memory (14) and configured to determine if each of the listed content items is available to the playback device and configured to identify for a given content item that is not available, an additional content item that is available that corresponds to the selection criteria.

10. The playback device of claim 9, comprising an output (13) operationally coupled to the processor (10), wherein the processor (10) is configured to provide identifying output information for the additional content to a user.

11. The playback device of claim 10, wherein the processor (10) is further configured to receive from the user a determination whether the additional content item is approved.

12. The playback device of claim 11, wherein the processor (10) is configured to identify a further additional content item if the approval is not received.

13. The playback device of claim 9, wherein the processor (10) is configured to expand the selection criteria to include a content item not previously identified if an additional content item is not available that corresponds to the selection criteria.

14. The playback device of claim 9, wherein the device (150) comprises a data input (12) and wherein the memory (14) is operationally coupled to the data input (12).

15. The playback device of claim 9, wherein the device (150) comprises a data input (160) operationally coupled to the memory (14), wherein the memory (14) is configured to receive the list of content items and the list of selection criteria from the data input (160).

16. A program portion stored on a machine readable medium, the program segment comprising:
a program segment for storing a list of content items and a list of selection criteria; and
a program segment for determining if each of the listed content items is available and for identifying for a given content item that is not available, an additional content item that is available that corresponds to the selection criteria.

17. The program portion of claim 16, comprising a program segment for providing identifying output information for the additional content to a user and for receiving from the user a determination whether the additional content item is approved.

18. The program portion of claim 16, comprising a program segment for expanding the selection criteria to include a content item not previously identified if an additional content item is not available that corresponds to the selection criteria and that is approved by a user.

19. The program portion of claim 16, comprising a program segment for expanding the selection criteria to include a content item not previously identified if an additional content item is not available that corresponds to the selection criteria.
